(19) United States
(12) Patent Application Publication
(10) Pub. No.: US 2005/0097070 A1
(43) Pub. Date: May 5, 2005

(54) Solution network decision trees

(76) Inventors: James Hunter Enis, Round Rock, TX (US); Jason Carden, Round Rock, TX (US); Michael Loranger, Georgetown, TX (US); Eric Sonnenstuhl, Round Rock, TX (US); Larry W. White, Austin, TX (US)

Correspondence Address: Stephen A. Terrile;HAMILTON & TERRILE, LLP, PO Box 203518, Austin, TX, 78720, US

(21) Appl. No.: 10/696,807

(22) Filed: Oct. 30, 2003

(51) Int. Cl. G06F 15/18; G06N 5/00; G06F 17/00; G06N 5/02

(52) U.S. Cl. 706/50; 706/46; 706/12

(57) ABSTRACT

A method for searching potential solutions within a solution network. The method includes authoring a solution to solve an issue, storing the solution within a decision tree relating to the issue, and searching the solution network based upon the issue. The searching includes accessing the decision tree relating to the issue.

### BACKGROUND OF THE INVENTION

1. Field of the Invention

The present invention relates to the field of customer support and more particularly to decision trees used within knowledge management systems for use with customer support systems.

2. Description of the Related Art

As the value and use of information continues to increase, individuals and businesses seek additional ways to process and store information. One option available to users is information handling systems. An information handling system generally processes, compiles, stores, and/or communicates information or data for business, personal, or other purposes thereby allowing users to take advantage of the value of the information. Because technology and information handling needs and requirements vary between different users or applications, information handling systems may also vary regarding what information is handled, how the information is handled, how much information is processed, stored, or communicated, and how quickly and efficiently the information may be processed, stored, or communicated. The variations in information handling systems allow for information handling systems to be general or configured for a specific user or specific use such as financial transaction processing, airline reservations, enterprise data storage, or global communications. In addition, information handling systems may include a variety of hardware and software components that may be configured to process, store, and communicate information and may include one or more computer systems, data storage systems, and networking systems.

With the proliferation of information handling systems such as home and business computers, the provision of timely and efficient diagnostic, support, and maintenance services to end users has become an important issue for manufacturers and sellers of computer systems. It is not uncommon for end users, especially new users, or experienced users attempting to add or reconfigure existing systems, to experience difficulties with their systems. For example the system might lock up (often referred to as freezing up or hanging). Also for example, a peripheral of the computer system, such as a hard drive disk drive, or printer, may not function properly. In other cases, the computer system may not recognize the peripheral. The solution to these sorts of problems may range from simply turning on power to the affected peripheral, reconnecting the affected peripheral, reconfiguring the computer system hardware or software, or installing a necessary software patch for the affected peripheral.

To diagnose and correct an issue, users typically have had to consult user's manuals that were included with the purchase of the system or peripheral. These manuals typically include troubleshooting tables or guides that attempt to diagnose a user's problem on the basis of symptoms recognized by the user. The effectiveness of the user's manual in assisting the users in identifying and correcting the problems encountered depends in large part on the skill of the computer user and the clarity and completeness of the user's manual. An inexperienced user may have difficulty in locating the source of the problem and in following the often confusing instructions in the user's manual. Moreover, user's manuals are often deficient in that they do not address every difficulty encountered by the user.

As an alternative or in addition to consulting a user's manual, a user experiencing difficulty with a system may consult diagnostic and support software stored locally on the system. The effectiveness of locally stored diagnostic software is limited in that the software programs generally display text files that have information similar to that found in user's manuals. As a result, users attempting to diagnose computer system problems through locally stored software programs face limitations similar to those faced by users attempting to diagnose system problems through a user's manual.

As another alternative, users may have access to a support or help line. A support or help line requires that the user contact a support technician or specialist at a central site. The support technician listens to the user's symptoms and attempts to diagnose the problem. This process often involves the support technician stepping the user through a series of diagnostic tests. If appropriate, the support technician may provide the user with instructions or tips for correcting the problem. The effectiveness of interpersonal diagnostic and support services of this sort depends in large part on the skill of the user being assisted. Regardless of the skill and knowledge of the support technician, the user will nevertheless have to describe correctly the problem being experienced, assist the support technician in diagnosing the problem, and perform the fix or correction suggested by the support technician.

One issue relating to the support system relates to providing consistent answers to similar questions throughout multiple agents. In a technical call center environment, there multiple subtle environmental variables present that cause delivery of static content (i.e., scripting) to be very difficult. Effectively and efficiently authoring solutions is equally challenging in a number of areas. For example, building knowledge that encompasses all issues while removing redundancy is challenging and authoring knowledge with a minimal amount of resources dedicated to the authoring process is challenging.

It is known to provide challenge response systems in which a question is offered and based off of the answer multiple responses are provided. Known systems present some challenges when functioning within technical support networks. These challenges are generally related to the search function and the authoring function of the challenge response system. For example, regarding the search function, known systems are focused on novice customer interactions. These systems begin with basic troubleshooting steps and progress forward in a linear path. More experienced customers or technicians may perform basic troubleshooting without assistance and want to work with systems that are redundant to their objective. Additionally, these systems generally require the creation of multiple troubleshooting scenarios for each combination of environmental variable. Also, the content stored within these systems are generally only available via a proprietary troubleshooting system. It is difficult to render the content as a stand alone knowledge or with any other tool.

Regarding the authoring function, known static systems expect only a one to one relationship with content. Each troubleshooting tree within known systems have unique content. Known systems are stand alone and do not interface with existing knowledge bases or other troubleshooting systems. Accordingly, it is difficult to use existing knowledge repositories as steps in a troubleshooting scenario while marinating the integrity of the existing knowledge. Additionally, known systems do not provide the ability to allow an author to create, edit and manipulate content via a drag and drop utility.

### SUMMARY OF THE INVENTION

In accordance with the present invention, a knowledge management system is provided with a decision tree module for generating solution network knowledge. The decision tree module includes a search portion, a presentation portion and an authoring portion.

The search portion allows both novice and experienced level users to efficiently use the solution network by using implied success. Trees are rendered in a format that allows a novice level user to navigate through trouble shooting steps one step at a time while a more experienced level user has the ability to pick and choose which steps to use. The troubleshooting steps are rendered in a hierarchical view that can be bypassed by skipping steps (i.e., by implied success). The search portion also includes a self learning symptom based search using the customer's perception of an issue. The decision tree links and strengthens or lessens relevancies of trees to customer symptoms (perceptions). Trees are also searchable by viewing a hierarchical view of trees organized based upon business needs. The search portion of the decision tree module also provides a troubleshooting tool; all steps within the decision tree are stand alone knowledge searchable and viewable as individual articles as well as trouble shooting trees.

The presentation portion of the decision tree module presents the results of a search conducted via the search portion of the decision tree module. The presentation portion of the decision tree module provides a user interface via which a searcher access results of a decision tree search

The authoring portion of the decision tree module provides a dynamic tool that reuses content and renders content based on the symptom and requested environmental variables. Environmental variables enable defining search variables across multiple platforms. The tool provides knowledge authors with the ability to link together existing knowledge articles creating troubleshooting trees or creating new articles available for use through searching the knowledge base or in other trees. The authoring portion enables knowledge authors to create content and troubleshoot trees by viewing the content in a process flow. The authoring portion of the decision tree module is web enabled to allow dragging and dropping of content, creating relationships and creating individual knowledge articles. The authoring portion of the decision tree module is dynamic to enable content reviewers to not only review individual pieces of knowledge but also the relationships of knowledge. If a step is changed that is associated with 10 trees, then not only should the step be reviewed, but all 10 trees should also be reviewed to ensure that the content relationship is still valid.

In one embodiment, the invention relates to a method for searching potential solutions within a solution network. The method includes authoring a solution to solve an issue, storing the solution within a decision tree relating to the issue, and searching the solution network based upon the issue. The searching includes accessing the decision tree relating to the issue.

In another embodiment, the invention relates to an apparatus for searching potential solutions within a solution network. The apparatus includes means for authoring a solution to solve an issue, means for storing the solution within a decision tree relating to the issue, and means for searching the solution network based upon the issue. The searching includes accessing the decision tree relating to the issue.

In another embodiment, the invention relates to a system for searching potential solutions within a solution network. The system includes an authoring module, a storing module, and a searching module. The authoring module enables authoring a solution to solve an issue. The storing module stores the solution within a decision tree relating to the issue. The searching module searches the solution network based upon the issue and the searching includes accessing the decision tree relating to the issue.

### BRIEF DESCRIPTION OF THE DRAWINGS

The present invention may be better understood, and its numerous objects, features and advantages made apparent to those skilled in the art by referencing the accompanying drawings. The use of the same reference number throughout the several figures designates a like or similar element.

FIG. 1 shows a block diagram of a solution environment.

FIG. 2 shows a block diagram of a solution network.

FIG. 3 shows a flow chart of the operation of the authoring portion of the decision tree module.

FIG. 4 shows a flow chart of the operation of the approval portion of the decision tree module.

FIG. 5 shows a flow chart of the operation of the search portion of the decision tree module.

FIGS. 6A and 6B, generally referred to as FIG. 6, show an exemplative decision tree authoring screen presentation.

FIG. 7 shows an exemplative step editor screen presentation of the authoring portion of the decision tree module.

FIGS. 8A, 8B, 8C and 8D, generally referred to as FIG. 8, show exemplative screen presentations of search result screen presentations of the presentation portion of the decision tree module.

### DETAILED DESCRIPTION

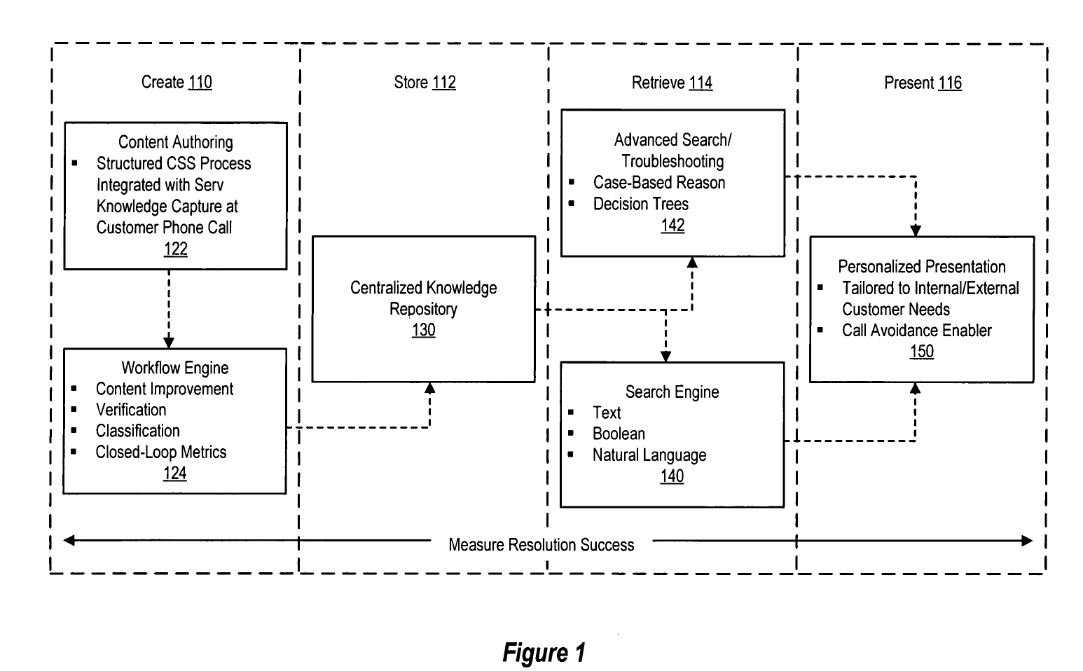

Referring to FIG. 1, a block diagram of the solution environment 100 is shown. More specifically, the solution environment 100 includes a create portion 110, a store portion 112, a retrieve portion 114 and a present portion 116.

The create portion 110 provides an environment in which knowledge is created. More specifically, the create portion 110 includes a content authoring portion 120 and a workflow engine portion 122. The content authoring portion provides a structured customer service and support (CSS) process which is integrated with a solution network server. The content authoring portion 122 also includes a knowledge capture portion which enables knowledge capture during communication with a customer. The workflow engine portion 124 provides a content improvement function, a knowledge verification function, a knowledge classification function as well as closed loop metrics for knowledge creation.

The store portion 112 provides the environment in which knowledge is stored. More specifically, the store portion 112 includes a centralized knowledge repository 130 in which knowledge that is created in the create portion 110 is stored.

The retrieve portion 114 provides the environment in which knowledge is retrieved. More specifically, the retrieve portion includes a search engine 140 in which various types of searches may be performed on the centralized knowledge repository 130. The searches may be in the form of, e.g, text searches, Boolean searches or natural language searches, etc. The retrieve portion also includes an advanced search and troubleshooting portion 142 which provides case based reason function as well as a decision tree function.

The present portion 116 provides the environment in which support knowledge is presented to a customer. More specifically, the present portion 116 provides a personalized presentation 150 of support knowledge. This information may be tailored to the internal or external customer needs. Providing a personalized presentation 150 becomes a call avoidance enabler in that a personalized presentation may enable a customer to obtain an answer to a problem without the need for a specific call to customer support.

The solution environment streamlines resource usage and enhances knowledge mining capabilities by eliminating the need for a third party or disconnected content creation group. The environment enables content creation applicable to the customer and business needs by integrating the content creation process and the call center technician phone intake process. The technical information is removed from a customer management tool and placed in a repository that can be used by other technicians. The environment thus enables continual use which allows the technical repository to evolve and grow while focusing knowledge mining on confirmed applicable incidents as compared to a perceived need.

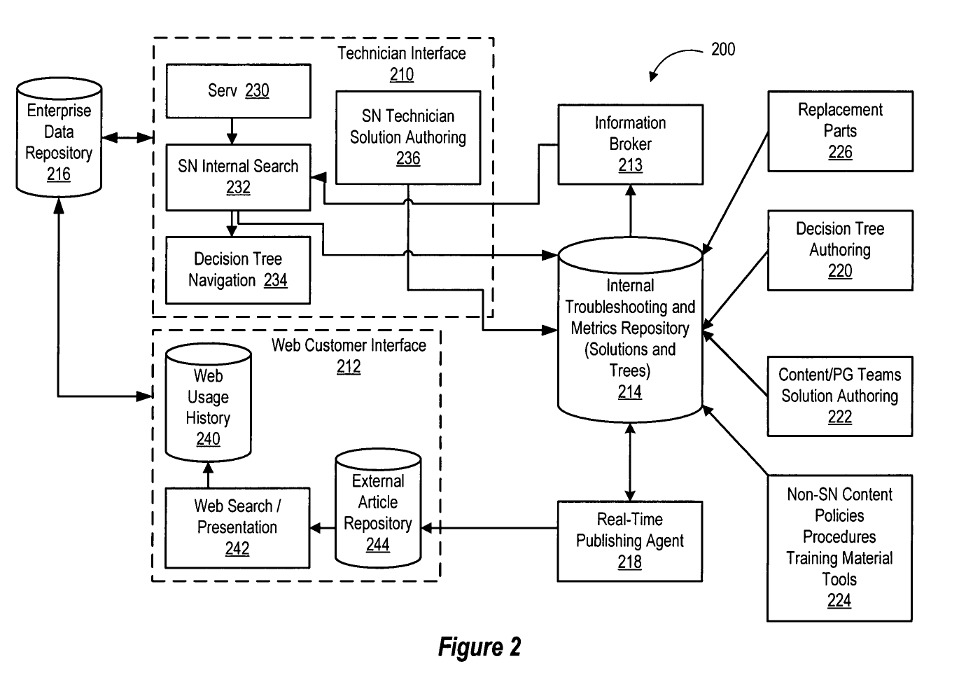

Referring to FIG. 2, a block diagram of a solution network 200 which instantiates the solution environment is shown. More specifically, the solution network 200 includes a technician interface module 210, a customer interface module 212, an information broker 213, an internal repository 214, an enterprise data repository 216, a real time publishing agent 218, a decision tree authoring module 220, a content/PG teams solution authoring module 222, a Non-solution network (Non-SN) content module 224 and a replacement parts module 226. The technician interface module 210 is coupled to the enterprise data repository 216, to the customer interface module 212 and to the information broker 213 as well as to the internal repository 214. The internal repository 214 is coupled to the information broker 213 and the real time publishing agent 218 as well as the decision tree authoring module 220, the content/PG teams solution authoring module 222, the Non-solution network (Non-SN) content module 224 and the replacement parts module 226. The real time publishing agent 218 is coupled to the customer interface 212.

The technician interface module 210 provides the user interface function between the technician and the solution network system 200. The customer interface module 212 provides the interface function for customers to the solution network system 200. The information broker 213 accesses information from the internal repository 214 and provides this information to the technician interface 210. The internal repository 214 provides a repository for troubleshooting solutions (both solutions and solution trees) as well as metrics relating to the solution network. The troubleshooting solutions may include articles, decision trees, and policies. The information broker 213 determines a best answer for a user based upon the user's answers to questions presented by the technician. The solution may be an action, such as rebooting the customer system, or the solution may be an actual part that needs to be replaced on the customer system. In the case of a part, the part number may be listed as the solution within the internal repository 214.

The enterprise data repository 216 is a customer database which includes histories on a customer including what system the customer has purchased, the components included with the system, profile history (i.e., contact information) as well as prior service history, prior rendered solutions and prior web support activity. Linking this customer information with the solution network 200 enables generating a solution faster and with fewer questions to the customer. Additionally, providing the component information to the solution network 200 enables solutions to be rendered that may be component specific. Additionally, maintaining service history on a customer basis enables the solution network 200 to tailor customer specific solutions as well as monitoring whether a particular customer is trying to take advantage of the service provider by obtaining excess replacement components.

The real time publishing agent 218 enables the solution network 200 to release knowledge immediately while the solution network 200 is running. Thus, technicians and customers have access to solutions stored within the repository 214 as soon as the solution is released, without having to wait for a new publish cycle to occur.

The technician interface 210 includes a server module 230, an internal search module 232, a decision tree navigation module 234 and a SN technician solution authoring module 236. The server module 230 provides the service on which the technician interface 210 resides. The SN internal search module 232 receives customer described issue and searches the internal repository 214 for possible solutions. The search module 232 systematically converts how a customer describes an issue into searchable keywords. For example, if a customer call and informs the technician that the customer system will not turn on, the search module may convert this to a technical search for solutions relating to a “No Power on Self Test (POST)” condition. The decision tree navigation module 234 controls the way that branches on a solution network decision tree are rendered. The technician solution authoring module 236 enables a technician to modify or augment a solution provided by the repository in real time (i.e., provide the modification or augmentation to the repository while the technician is interacting with a customer). A particular line of business can see these augmentations either immediately or after release from incubation. The level of incubator at which the line of business is notified is customizable depending on the desires of each line of business.

The customer interface 212 is, for example a web customer interface, which is accessible via the internet. The customer interface 212 includes a web usage history module 240, a web search and presentation module 242 and an external article repository 244. The web usage history module 240 maintains a history of the interaction between a customer and the solution network 200. This history is maintained so that if an issue is forwarded from the customer interface 212 to the technician interface 210, the technician can easily determine what questions or answers have already been tried by the user when attempting self-help via the customer interface 212 before enlisting technician assisted support. The web search/presentation module 242 is the module with which the customer interacts when accessing the customer interface 212. The external article repository 244 is a repository of documents that have been released for public access.

The decision tree authoring module 220 stores information within the repository 214 which enables knowledge to be linked together in a process oriented fashion. The content/PG teams solution authoring module 222 enables the authoring of stand alone knowledge solutions and applies the appropriate attributes to this knowledge. The Non-solution network (Non-SN) content module 224 stores information regarding policies and procedures within the repository 214. For example, a particular customer might have certain associated business policies that a technician might be expected to apply. The Non-SN content module 224 thus essentially applies a filter to particular customer situations. The Non-SN content module 224 also includes training material for training support technicians. This training material includes extra support detail than is provided to technicians who are interacting with customers. The Non-SN content module 224 also provides a conduit into other support tools that might not have been stored within the repository 214. The replacement parts module 226 develops solutions relating to which replacement parts are associated with particular systems.

The solution network 200 includes a decision tree module which includes a decision tree search portion which is instantiated within the internal search module 232 and web search module 242 and an authoring portion which is instantiated within the decision tree authoring module 220.

The decision tree search portion allows both novice and experienced level users to efficiently use the solution network by using implied success. Trees are rendered in a format that allows a novice level user to navigate through trouble shooting steps one step at a time while a more experienced level user has the ability to pick and choose which steps to use. The troubleshooting steps are rendered in a hierarchical view that can be bypassed by skipping steps (i.e., by implied success). The search portion also includes a self learning symptom based search using the customer's perception of an issue. The decision tree links and strengthens or lessens relevancies of trees to customer symptoms (perceptions). Trees are also searchable by viewing a hierarchical view of trees organized based upon business needs. The decision tree search portion also provides a troubleshooting tool; all steps within the decision tree are stand alone knowledge searchable and viewable as individual articles as well as trouble shooting trees.

The authoring portion of the decision tree module provides a dynamic tool that reuses content and renders content based on the symptom and requested environmental variables. The tool provides knowledge authors with the ability to link together existing knowledge articles creating troubleshooting trees or creating new articles available for use through searching the knowledge base or in other trees. The authoring portion enables knowledge authors to crate content and troubleshoot trees by viewing the content in a process flow. The authoring portion of the decision tree module is web enabled to allow dragging and dropping of content, creating relationships and creating individual knowledge articles. The authoring portion of the decision tree module is dynamic to enable content reviewers to not only review individual pieces of knowledge but also the relationships of knowledge. If a step is changed that is associated with 10 trees, then not only should the step be reviewed, but all 10 trees should also be reviewed to ensure that the content relationship is still valid.

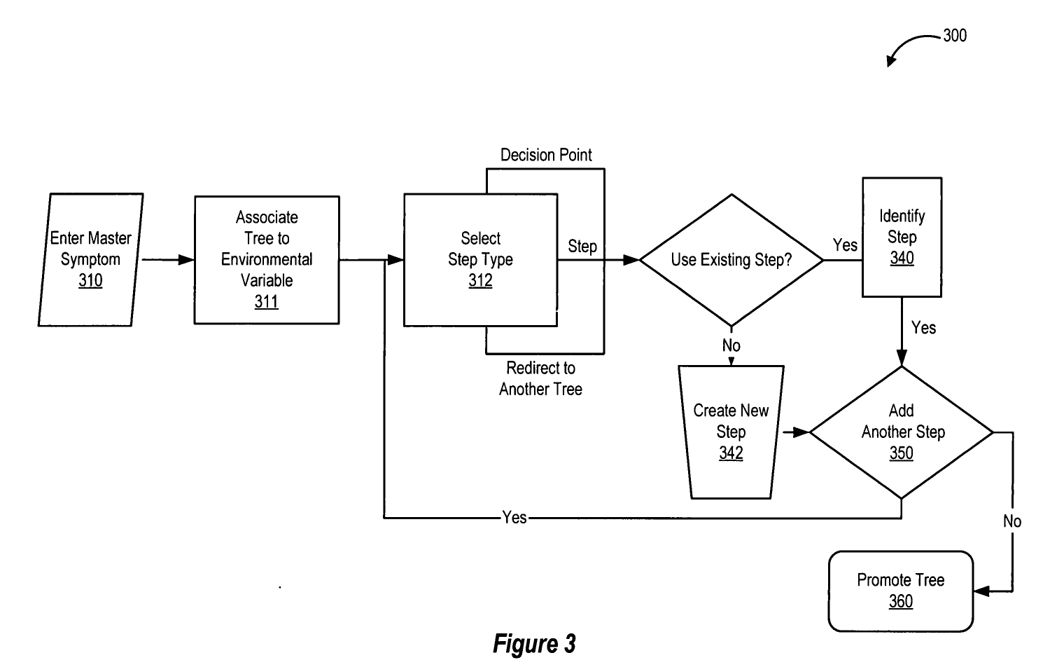

Referring to FIG. 3, a flow chart of the operation of the authoring portion 300 of the decision tree module is shown. More specifically, the authoring portion 300 starts with an operator entering a master symptom at step 310. Next, the authoring portion determines whether to associate a tree with an environmental variable at step 311, i.e., to associate symptom with a particular group as defined by an environmental variable. The authoring portion then selects a setup type at step 312. The setup type may be a decision point type, a step type or a redirect to another tree type. At step 330, the authoring portion determines whether to use an existing step or to create a step.

If the authoring portion 300 determines to use an existing step, then the authoring portion 300 proceeds to step 340 where the authoring portion 300 identifies an existing step to use. If the authoring portion 300 determines to create a step, then the authoring portion 300 proceeds to step 342 where the authoring portion 300 creates a new step to use within the decision tree. To use an existing step, a list of all available steps is presented and the appropriate step is chosen from the list of available steps. To create a step, a title and description are generated for the new step. The description may be a document (such as an HTML document) which includes information on how to perform a step, e.g, the description provides the “how to” of how to address a particular symptom.

After an existing step is used or a new step is created, then the authoring portion 300 proceeds to decision step 350 where the authoring portion determines whether to add another step to the decision tree. If the authoring portion 300 determines to add another step, then the process returns to step 312. If the authoring portion 300 determines that there are no other steps to add at this time, then the process proceeds to step 360 where the tree is promoted, i.e., the tree is provided to an approval process.

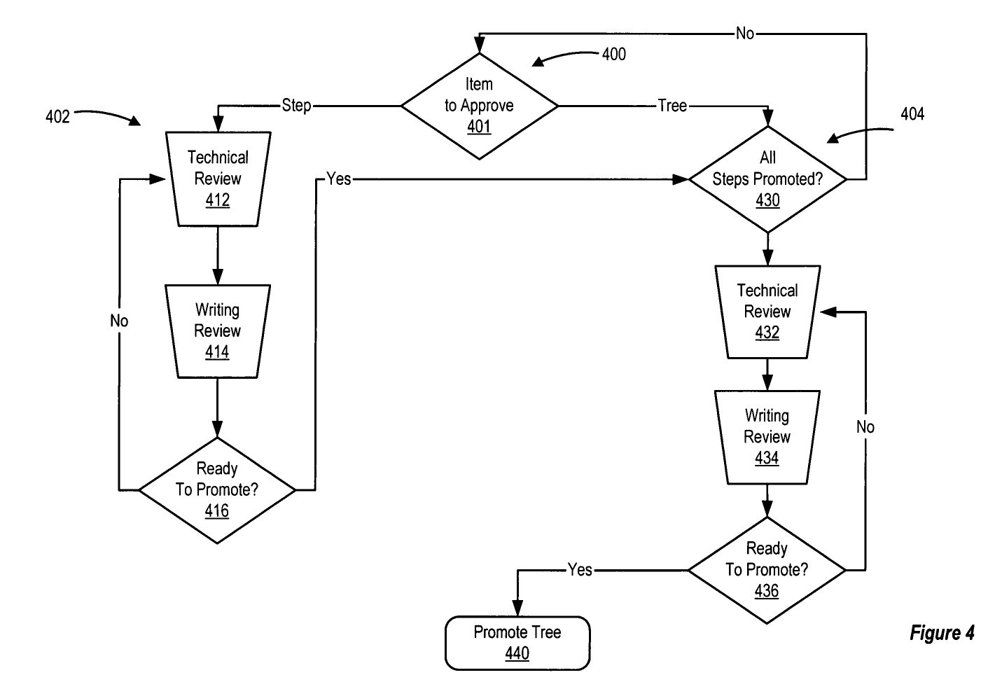

Referring to FIG. 4, a flow chart of the operation of an approval process 400 of the authoring portion of the decision tree module is shown. More specifically, the approval process begins by analyzing the item to approve at step 401. If the item is an individual step, then the approval process 400 proceeds down a step path 402; if the item is a decision tree, then the approval process 400 proceeds do a decision tree path 404.

When proceeding down the step path 402, the step receives a technical review (i.e., a review to determine whether the step is technically correct) at step 412. The individual step then receives a writing review (i.e., a review to determine whether the step is grammatically correct and well written) at step 414. Next, the step is analyzed to determine whether the step is ready to promote at step 416. If not, then the process returns to the technical review at step 412 so that the step may be modified if necessary. If the step is ready to promote, then the approval process proceeds to the decision tree path 404.

When proceeding do the decision tree path 404, the approval process determines whether all steps have been promoted at step 430. If all steps have not been promoted, then the process returns to step 401 and another item is retrieved for the approval process. If all steps have been promoted, then the decision tree receives a technical review (i.e., a review to determine whether the decision tree is technically correct) at step 432. The decision tree then receives a writing review (i.e., a review to determine whether the decision tree is grammatically correct and well written) at step 434. Next, the decision tree is analyzed to determine whether the decision tree is ready to promote at step 436. If all steps have been approved and the decision tree has been approved, then the approval process completes and the tree is promoted at step 440. When the tree is promoted at step 440, then the decision tree is available for general use within the solution network 200.

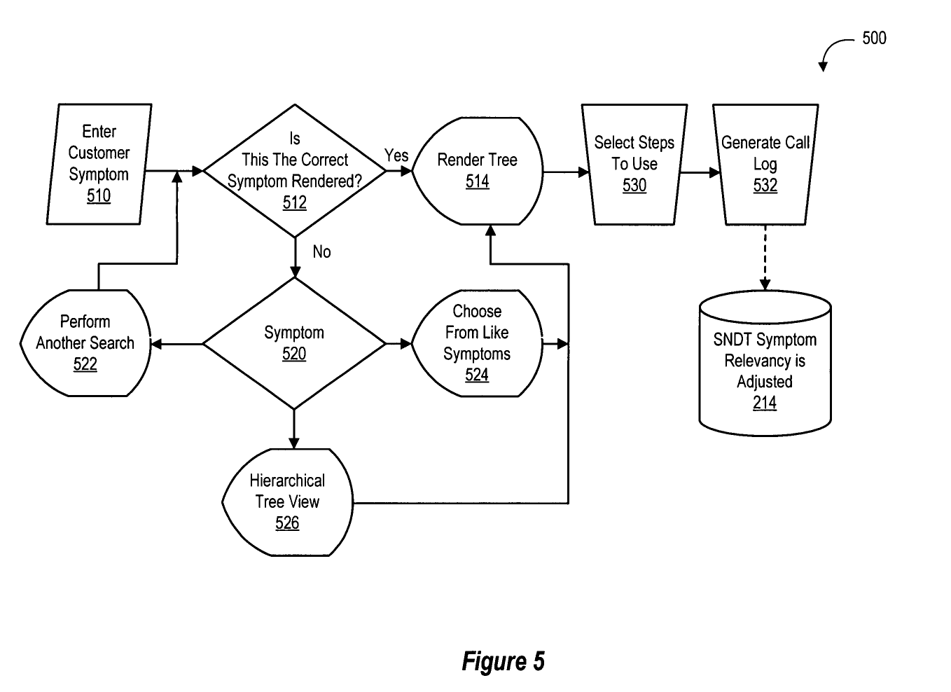

Referring to FIG. 5, a flow chart of the operation of the search portion 500 of the decision tree module is shown. More specifically, the search portion 500 of the decision tree module starts by entering a customer symptom at step 510. The solution network 200 renders a symptom based upon the customer symptom. The search portion 500 then reviews the rendered symptom to determine whether the correct symptom was rendered at step 512. If the correct symptom is rendered, then the search portion 500 renders the appropriate decision tree at step 514.

If the correct symptom is not rendered then the search portion 500 proceeds to a symptom decision at step 520. The symptom decision may be presented via a symptom screen presentation. The search portion 500 provides a searcher with options including whether to perform another symptom search, whether to choose from like symptoms, or whether to present a hierarchical tree view at step 520. If the operator elects to perform another symptom search, then the search portion proceeds to step 522 and another seach is preformed. If the operator elects to choose from like symptoms, then the operator is provided with a list of like symptoms from which to choose at step 524 and the search portion proceeds to render the tree associated with the chosen like symptom at step 514. If the operator elects to have the search portion present a hierarchical tree view, then the operator is provided with hierarchical tree view of various symptoms from which to choose at step 526 and the search portion proceeds to render the tree associated with the chosen like symptom at step 514.

After the tree is rendered, then the search portion enables the operator to select the steps to use to address a customer symptom at step 530. After the steps are selected, then the search portion generates a call log of the call, the customer symptom and the steps selected to address the customer issue at step 532. The call log then provides information to the solution network decision tree stored within the repository 214 so that the symptom relevancy may be adjusted based upon the result of the customer call.

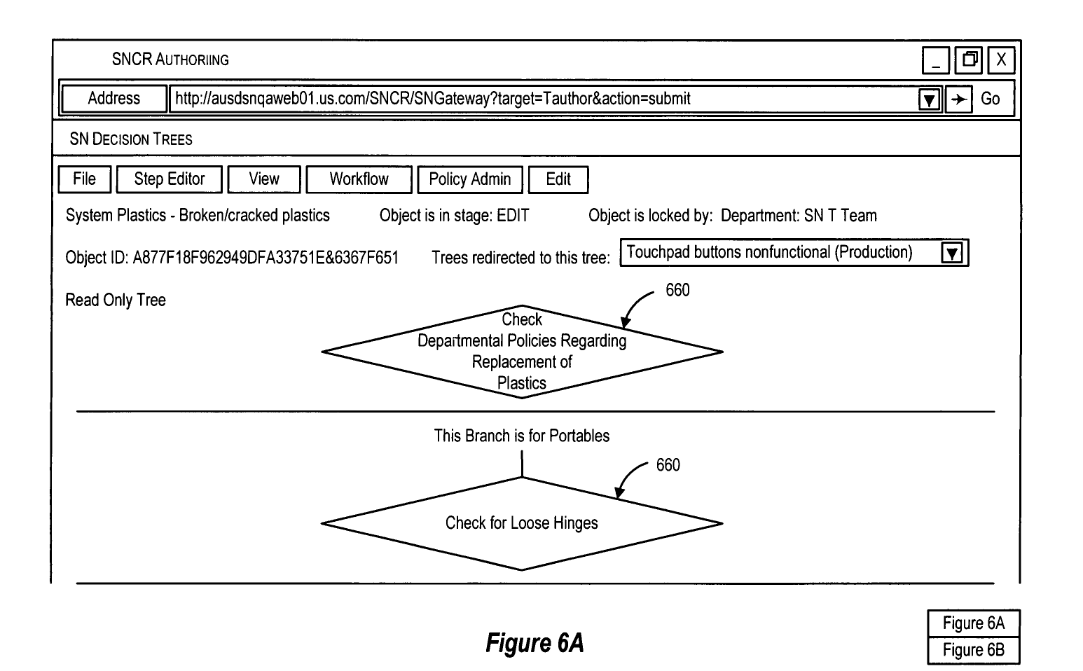

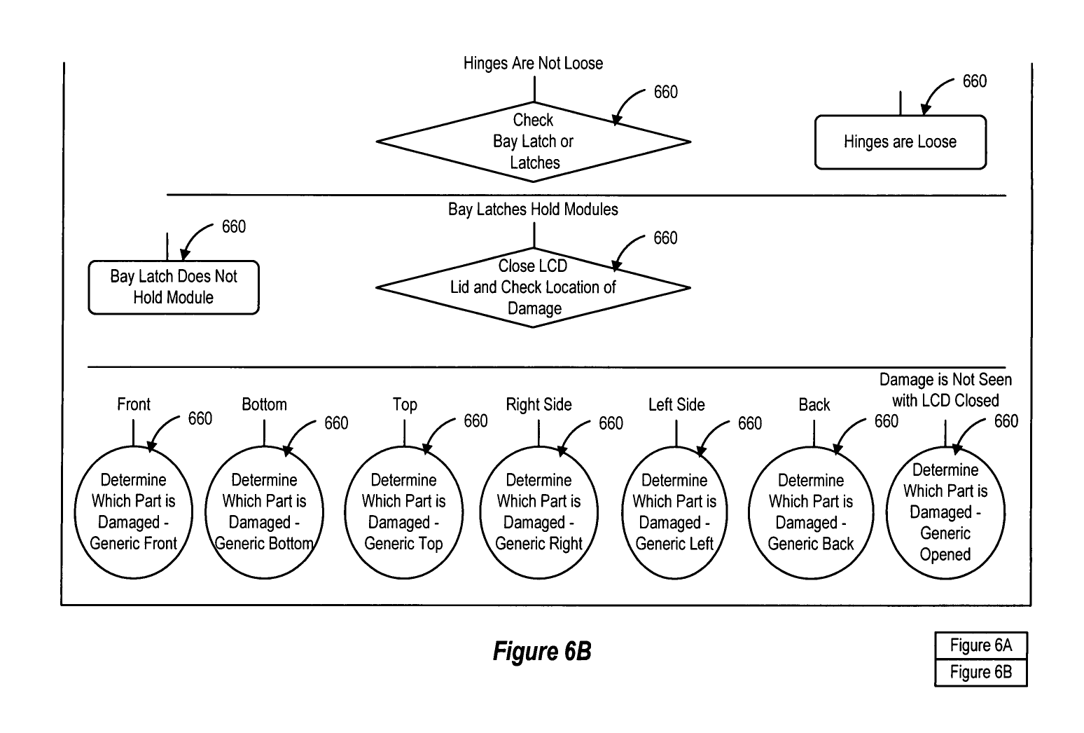

FIG. 6 shows an exemplative screen presentation of a decision tree authoring screen presentation 600. The decision tree authoring presentation 600 presents a decision tree author with information for use when authoring a decision tree. More specifically, the decision tree authoring screen presentation includes an authoring options portion 610 and a decision tree information portion 620.

The authoring options portion provides a plurality of options that a decision tree author may actuate. More specifically, the authoring options portion 610 includes a file option 640, a step editor option 642, a view option 644, a work flow option 646, a policy admin option 648 and an edit option 650. The file option 640 enables a decision tree author to attach a graphic, such as a .pdf file or a jpeg image, to a step within the decision tree. The step editor option 642 enables a decision tree author to add or change a step. The view option 644 enables a decision tree author to choose between presenting a decision tree in a graphical editing mode or in a technician mode. The graphical editing mode presents the decision tree as a flow chart that enables the decision tree author to observe the actual flow among the steps of the decision tree. The technician mode enables the decision tree author to observe the decision tree as a technician accessing the decision tree would so observe. The work flow option 646 provides the decision tree author with information regarding where the decision tree is within the decision tree review process. The policy admin option 648 enables an operator to add policy information to a particular step of the decision tree. E.g., a return policy may be added to a step that identifies a system as not repairable. The edit option 650 enables a decision tree author to change the flow of the steps of the particular decision tree.

The decision tree information portion 620 presents a decision tree as a graphical mode (i.e., a flow chart) that associates steps with a flow to facilitate the authoring of the flow of steps within a decision tree. In the decision tree information portion 620, each step 660 may be individually accessed by actuating (e.g., by double clicking on) the step 660. When a step 660 is accessed, the description corresponding to the step is presented, e.g., in a separate window.

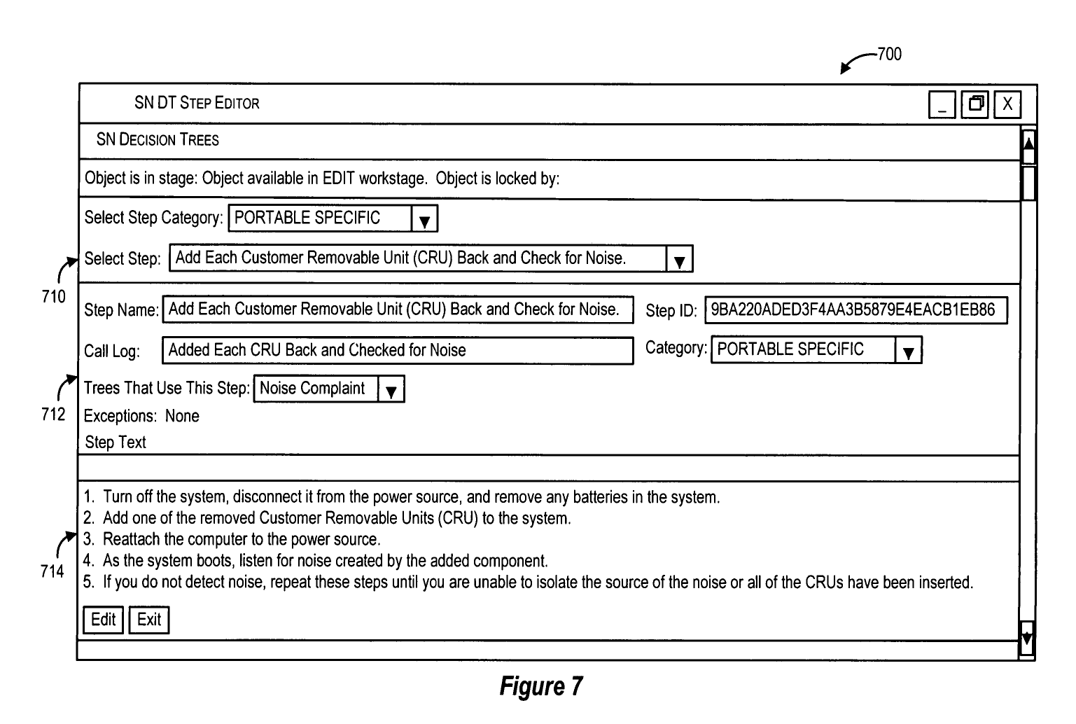

FIG. 7 shows an exemplative screen presentation of a step editor screen presentation of the authoring portion of the decision tree module. More specifically, the solution network decision tree step editor presentation 700 includes a step name search portion 710, a step select portion 712 and a step document portion 714.

The step name search portion 710 enables a step author to search on a particular category (i.e., a particular environmental variable) or on a particular step name. The step select portion 712 enables a step author to select particular step or type of step and to create a new step from an existing step. If the step author is generating an entirely new step, then the fields within the step select portion 712 are blank. The step select portion 712 includes a call log entry 720. The call log entry enables a step author to indicate the entry that will be provided to a call log when the corresponding step is accessed by a support technician. The step select portion 712 also includes an environmental variable entry 722. The environmental variable entry 722 enables a step author to identify a step as applicable across multiple platforms.

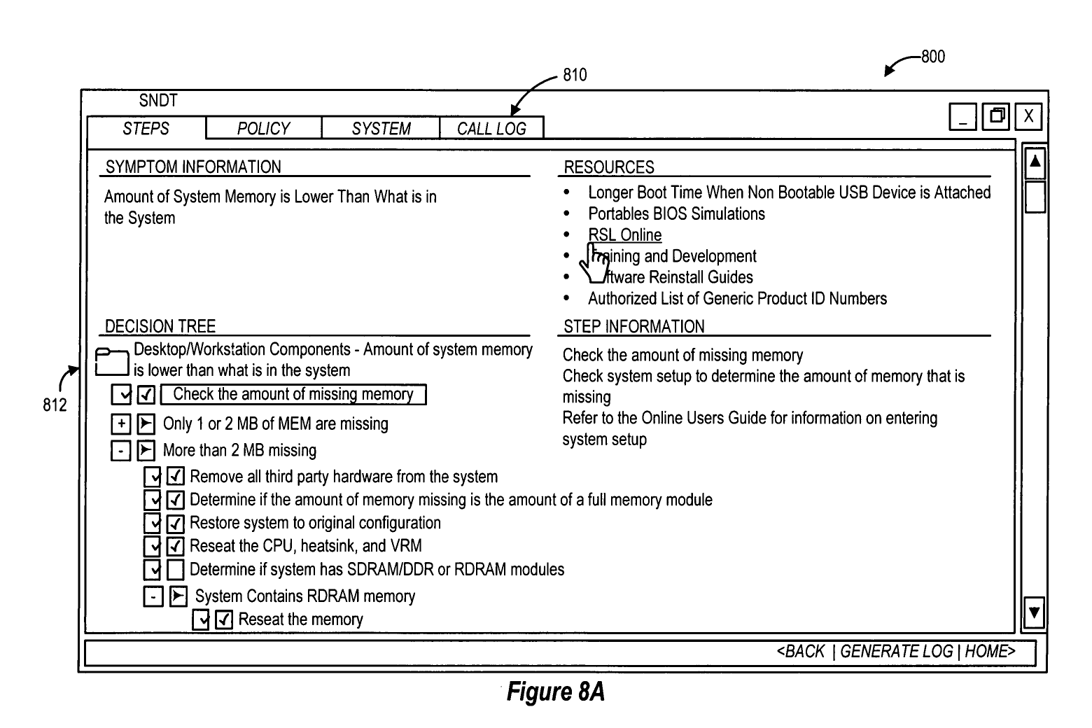

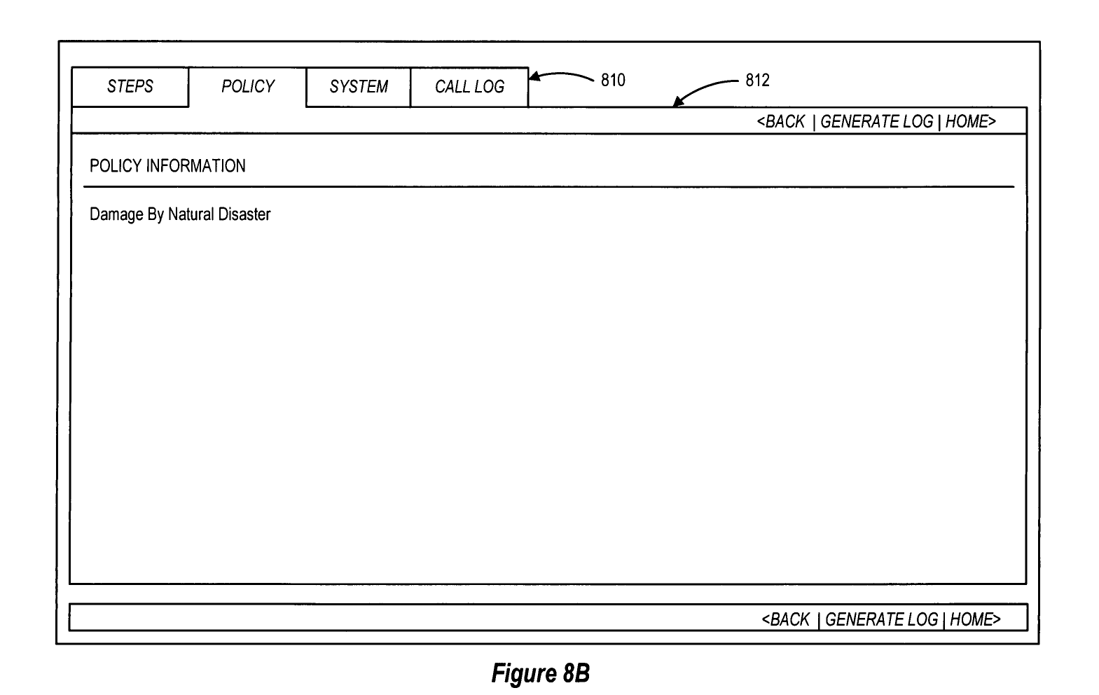

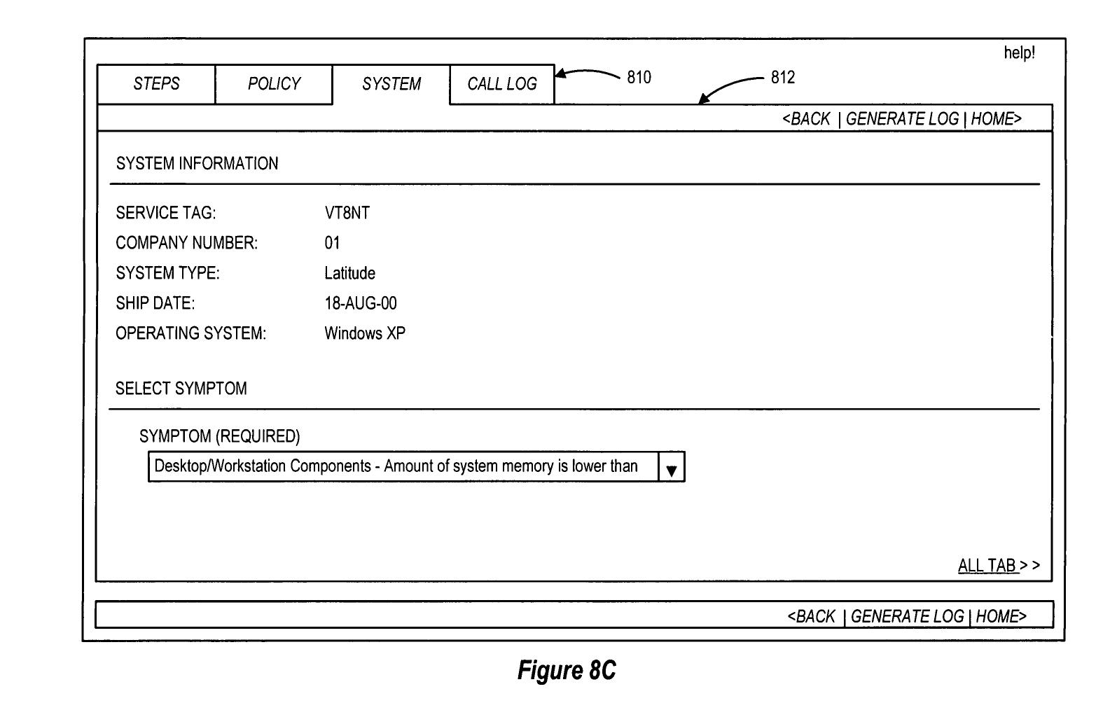

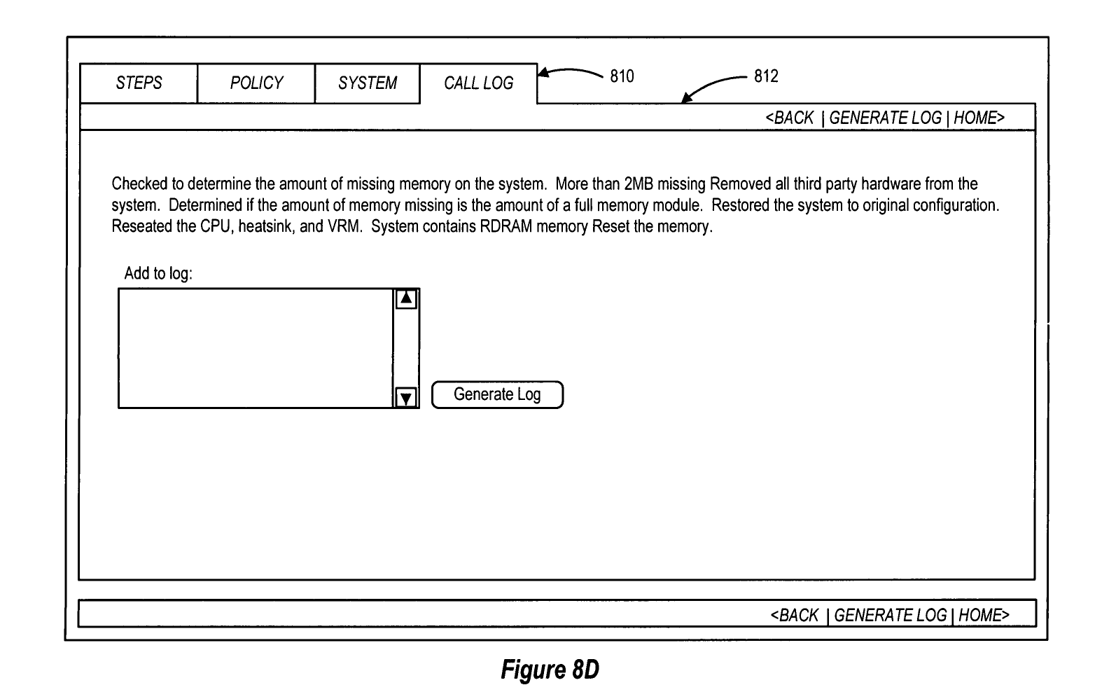

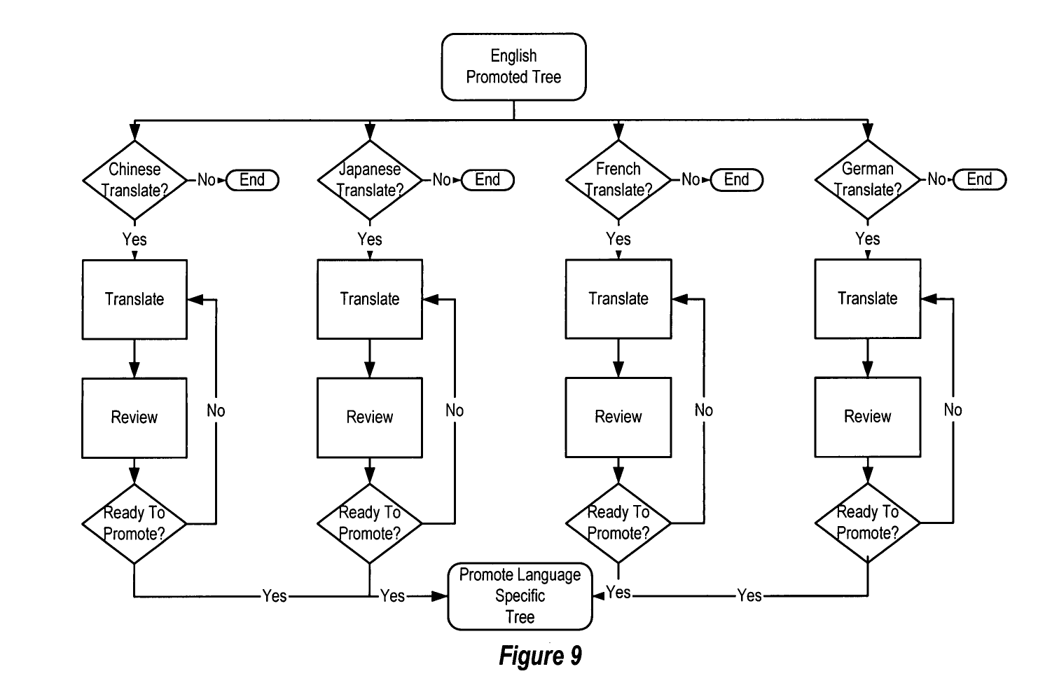

FIGS. 8A, 8B, 8C and 8D show exemplative screen presentations of the search portion of the decision tree module. More specifically, the solution network decision search portion screen presentation 800 includes a navigation portion 810 as well as a presentation portion 812. The presentation portion 810 includes a steps tab 820, a policy tab 822, a system tab 824 and a call log tab 826.

Actuating the steps tab 820 causes the solution network 200 to present a step presentation within the presentation portion 812 (See, e.g., FIG. 8A). More specifically, the step presentation provides a searcher with information relating to steps within the decision tree. The step presentation includes a symptom portion under the heading “Symptom Information”. The symptom portion provides a symptom description that the solution network 200 associated with a customer provided symptom. The step presentation includes a resources portion which provides a searcher with links to other knowledge solutions that may be relevant to a particular step. The step presentation includes a decision tree portion which sets forth the step titles within a particular decision tree as well as providing an indication of whether a particular step has been performed (as indicated by checking the box next to the step). The particular step that is selected (as indicated by the step name being highlighted, see, e.g., the “Check the amount of missing memory” step) provides the corresponding step document under the heading “step information”.

Actuating the policy tab 822 causes the solution network 200 to present a policy presentation within the presentation portion 812 (See, e.g., FIG. 8B). The policy presentation presents information about to policies relating to a particular step. For example, the policy may indicate that the damage may have occurred by a natural disaster.

Actuating the system tab 824 causes the solution network 200 to present a system presentation within the presentation portion 812 (See, e.g., FIG. 8C). The system presentation provides a searcher with information about the system for which the search is being performed. The system information includes a unique system identifier such as a service tag, a company identifier, a system type, a system ship date and operating system information. It will be appreciated that additional system information may be provided within the system presentation. The system presentation also includes a symptom selection portion which enables a searcher to associate a symptom with a system.

Actuating the call log tab 826 causes the solution network 200 to present a call log presentation within the presentation portion 812 (See, e.g., FIG. 8D). More specifically, the call log presentation presents a log of the various steps that may have been performed with respect to a particular system. The call log presentation also allows a searcher to add to the call log.

The present invention is well adapted to attain the advantages mentioned as well as others inherent therein. While the present invention has been depicted, described, and is defined by reference to particular embodiments of the invention, such references do not imply a limitation on the invention, and no such limitation is to be inferred. The invention is capable of considerable modification, alteration, and equivalents in form and function, as will occur to those ordinarily skilled in the pertinent arts. The depicted and described embodiments are examples only, and are not exhaustive of the scope of the invention.

For example, the decision tree module can be modified to support decision trees in different languages. For example, FIG. 9 shows the operation of process for supporting a decision tree with a plurality of languages. When an English tree is promoted, e.g., via step 420, then the decision tree enters the process to determine whether to translate the tree into a plurality of additional languages. Each language includes a corresponding translation and review process. The tree may be translated into multiple languages either serially or in parallel.

Also, for example, the above-discussed embodiments include software modules that perform certain tasks. The software modules discussed herein may include script, batch, or other executable files. The software modules may be stored on a machine-readable or computer-readable storage medium such as a disk drive. Storage devices used for storing software modules in accordance with an embodiment of the invention may be magnetic floppy disks, hard disks, or optical discs such as CD-ROMs or CD-Rs, for example. A storage device used for storing firmware or hardware modules in accordance with an embodiment of the invention may also include a semiconductor-based memory, which may be permanently, removably or remotely coupled to a microprocessor/memory system. Thus, the modules may be stored within a computer system memory to configure the computer system to perform the functions of the module. Other new and various types of computer-readable storage media may be used to store the modules discussed herein. Additionally, those skilled in the art will recognize that the separation of functionality into modules is for illustrative purposes. Alternative embodiments may merge the functionality of multiple modules into a single module or may impose an alternate decomposition of functionality of modules. For example, a software module for calling sub-modules may be decomposed so that each sub-module performs its function and passes control directly to another sub-module.

Consequently, the invention is intended to be limited only by the spirit and scope of the appended claims, giving full cognizance to equivalents in all respects.

1. A method for searching potential solutions within a solution network comprising:
authoring a solution to solve an issue;
storing the solution within a decision tree relating to the issue; and,
searching the solution network based upon the issue, the searching including accessing the decision tree relating to the issue.

2. The method of claim 1 further comprising:
presenting results of a search in a graphical presentation.

3. The method of claim 2 further comprising:
the presenting includes rendering results of the search in a hierarchical view, the hierarchical view enabling a user to bypass certain solutions by skipping steps.

4. The method of claim 2 wherein:
the presenting includes rendering results of the search in a tree format, the tree format enabling navigating through trouble shooting steps one step at a time, the tree format enabling a user to pick and choose particular steps to access.

5. The method of claim 1 further comprising:
the searching includes a self learning symptom based search using a perception of an issue by the customer.

6. The method of claim 5 wherein:
the decision tree links and strengthens or lessens relevancies of trees to customer symptoms.

7. The method of claim 1 wherein:
the searching includes enabling trees to be searchable by viewing a hierarchical view of trees organized based upon business needs.

8. The method of claim 1 wherein:
the storing the solution within a decision tree provides a dynamic tool that reuses content and renders content based on the symptom and requested environmental variables.

9. The method of claim 1 wherein:
the storing the solution within a decision tree includes linking together existing knowledge articles to generate troubleshooting trees.

10. The method of claim 1 wherein:
the authoring the solution includes creating new articles available for use through searching the knowledge base in other decision trees.

11. The method of claim 1 wherein:
the authoring the solution includes creating content and troubleshooting trees by viewing an issue in a process flow.

12. The method of claim 1 wherein:
the authoring the solution includes dragging and dropping of content to create relationships and create individual knowledge articles.

13. The method of claim 1 wherein:
the authoring the solution is dynamic to enable content reviewers to review relationships between individual pieces of knowledge.

14. An apparatus for searching potential solutions within a solution network comprising:
means for authoring a solution to solve an issue;
means for storing the solution within a decision tree relating to the issue; and,
means for searching the solution network based upon the issue, the searching including accessing the decision tree relating to the issue.

15. The apparatus of claim 14 further comprising:
means for presenting results of a search in a graphical presentation.

16. The apparatus of claim 15 further comprising:
the means for presenting includes means for rendering results of the search in a hierarchical view, the hierarchical view enabling a user to bypass certain solutions by skipping steps.

17. The apparatus of claim 15 wherein:
the means for presenting includes means for rendering results of the search in a tree format, the tree format enabling navigating through trouble shooting steps one step at a time, the tree format enabling a user to pick and choose particular steps to access.

18. The apparatus of claim 14 further comprising:
the means for searching includes means for performing a self learning symptom based search using a perception of an issue by the customer.

19. The apparatus of claim 18 wherein:
the decision tree links and strengthens or lessens relevancies of trees to customer symptoms.

20. The apparatus of claim 14 wherein:
the means for searching includes means for enabling trees to be searchable by viewing a hierarchical view of trees organized based upon business needs.

21. The apparatus of claim 14 wherein:
the means for storing the solution within a decision tree provides a dynamic tool that reuses content and renders content based on the symptom and requested environmental variables.

22. The apparatus of claim 14 wherein:
the means for storing the solution within a decision tree includes means for linking together existing knowledge articles to generate troubleshooting trees.

23. The apparatus of claim 14 wherein:
the means for authoring the solution includes means for creating new articles available for use through searching the knowledge base in other decision trees.

24. The apparatus of claim 14 wherein:
the means for authoring the solution includes means for creating content and troubleshooting trees by viewing an issue in a process flow.

25. The apparatus of claim 14 wherein:
the means for authoring the solution includes dragging and dropping of content to create relationships and create individual knowledge articles.

26. The apparatus of claim 14 wherein:
the means for authoring the solution is dynamic to enable content reviewers to review relationships between individual pieces of knowledge.

27. A system for searching potential solutions within a solution network comprising:
an authoring module, the authoring module enabling authoring a solution to solve an issue;
a storing module, the storing module storing the solution within a decision tree relating to the issue; and,
a searching module, the searching module searching the solution network based upon the issue, the searching including accessing the decision tree relating to the issue.

28. The system of claim 27 further comprising:
a presenting module, the presenting module presenting results of a search in a graphical presentation.

29. The system of claim 28 further comprising:
the presenting module renders results of the search in a hierarchical view, the hierarchical view enabling a user to bypass certain solutions by skipping steps.

30. The system of claim 28 wherein:
the presenting module renders results of the search in a tree format, the tree format enabling navigating through trouble shooting steps one step at a time, the tree format enabling a user to pick and choose particular steps to access.

31. The system of claim 27 further comprising:
the searching module performs a self learning symptom based search using a perception of an issue by the customer.

32. The system of claim 29 wherein:
the decision tree links and strengthens or lessens relevancies of trees to customer symptoms.

33. The system of claim 27 wherein:
the searching module enables trees to be searchable by viewing a hierarchical view of trees organized based upon business needs.

34. The system of claim 27 wherein:
the storing module stores includes a dynamic tool that reuses content and renders content based on the symptom and requested environmental variables.

35. The system of claim 27 wherein:
the storing module links together existing knowledge articles to generate troubleshooting trees.

36. The system of claim 27 wherein:
the authoring module creates new articles available for use through searching the knowledge base in other decision trees.

37. The system of claim 27 wherein:
the authoring module creates content and troubleshooting trees by viewing an issue in a process flow.

38. The system of claim 27 wherein:
the authoring module enables dragging and dropping of content to create relationships and create individual knowledge articles.

39. The system of claim 27 wherein:
the authoring module is dynamic to enable content reviewers to review relationships between individual pieces of knowledge.
